(19) United States
(12) Patent Application Publication
(10) Pub. No.: US 2016/0276752 A1
(43) Pub. Date: Sep. 22, 2016

(54) Dual Band Smart Patch Antenna for Satellite Communication

(71) Applicant: Michael Pedigo, Watsonville, CA (US)

(72) Inventor: Michael Pedigo, Watsonville, CA (US)

(21) Appl. No.: 14/664,124

(22) Filed: Mar. 20, 2015

(51) Int. Cl. H01Q 21/30; H01Q 9/04; H01Q 21/00

(52) U.S. Cl. CPC H01Q 21/30; H01Q 21/0006; H01Q 9/045

(57) ABSTRACT

The present invention offers and effective, compact, cost efficient, smart antenna optimized for the 1.6 GHz and 2.5 GHz frequency range. The present invention provides a compact satellite bridge device optimized to communicate with wireless satellites without the need for bulky antennas. The antenna of the present invention can be used in a variety of products, such as satellite communications access points and satellite phones.

### BACKGROUND OF THE INVENTION

1. Field of the Invention

The present invention relates to an antenna, particularly to a dual band tuned for both 1.6 GHz and 2.5 GHz compact low cost smart antenna for satellite and other wireless communications use.

2. Description of Related Art

Smart antennas, also known as antenna arrays, are a technology using two or more individual antenna elements to form an antenna array. The smart antenna changes the array pattern in response to the signal environment to improve the reception of the signal. The smart antenna works by adjusting the phase and amplitude of the signals received by each antenna element. The antenna gain is maximized in the desired direction and the gain is minimized or suppressed direction of interference signals. In essence the smart antenna uses the individual antenna elements to focus and steer the beam of the received signal. A smart antenna has the potential to increase the range, bandwidth, and security over a traditional antenna.

However, traditionally smart antennas have faced several disadvantages. For example, smart antennas can be very complex, which makes optimizing a smart antenna for a particular function tedious. Furthermore, the complexity results in a larger sized antenna and increased cost of the smart antenna. These disadvantages become magnified in the consumer device marketplace where consumers desire small and attractive communications devices and universal access.

Currently most satellite wireless communications occur in the 1.6 GHz and 2.5 GHz frequency range. However, optimizing a smart antenna for this frequency range requires much experimentation to find the optimal antenna array orientations. Therefore, there is a long felt need in the art for an effective, compact, cost efficient, smart antenna optimized for the 1.6 GHz and 2.5 GHz frequency range.

### SUMMARY OF THE INVENTION

The innovation of the present invention offers an effective, compact, cost efficient, smart antenna optimized for the 1.6 GHz and 2.5 GHz frequency range. The present invention provides a compact satellite bridge device optimized to communicate with wireless satellites without the need for bulky antennas. The antenna of the present invention can be used in a variety of products, such as satellite communications access points and satellite phones.

Many other objects, features, advantages, benefits, improvements and non-obvious unique aspects of the present invention, as well as the prior problems, obstacles, limitations and challenges that are addressed, will be evident to the reader who is skilled in the art, particularly when this application is considered in light of the prior art. It is intended that such objects, features, advantages, benefits, improvements and non-obvious unique aspects are within the scope of the present invention, the scope of which is limited only by the claims of this and any related patent applications and any amendments thereto.

To the accomplishment of all the above, it should be recognized that this invention may be embodied in the form illustrated in the accompanying drawings, attention being called to the fact, however, that the drawings are illustrative only, and that changes may be made in the specifics illustrated or described.

### BRIEF DESCRIPTION OF THE DRAWINGS

A better understanding of the business method and system of the present invention may be had from the drawings as described in greater detail in the DETAILED DESCRIPTION OF PREFERRED EMBODIMENT section which follows:

FIG. 1 is a block diagram the major components of the preferred embodiment of the present invention;

FIG. 2 is a circuit diagram the microprocessor circuit board of the preferred embodiment of the present invention;

FIG. 3 is a circuit diagram of the antenna and phase shifter circuit board of the preferred embodiment of the present invention;

FIG. 4 is a detailed view circuit diagram of the phase shifter 1 and 2 circuit board of the preferred embodiment of the present invention;

FIG. 5 is a detailed view circuit diagram of the phase shifter 3 circuit board of the preferred embodiment of the present invention;

FIG. 6 is a detailed view circuit diagram of the satellite modem daughter board of the preferred embodiment of the present invention.

### DETAILED DESCRIPTION OF PREFERRED EMBODIMENT

The present invention relates to an antenna, particularly to a dual band tuned for both 1.6 GHz and 2.5 GHz compact low cost smart antenna for satellite communications use. A smart antenna can steer its main beams towards desired locations by constructive interference while also destructively interfering with undesired signals. Smart antennas are a key technological development in wireless communications that increases the capacity and efficiency of antennas. The preferred embodiment of the present invention is able to focus a beam in 25 different directions in a hemisphere with a 3 decibel loss in gain.

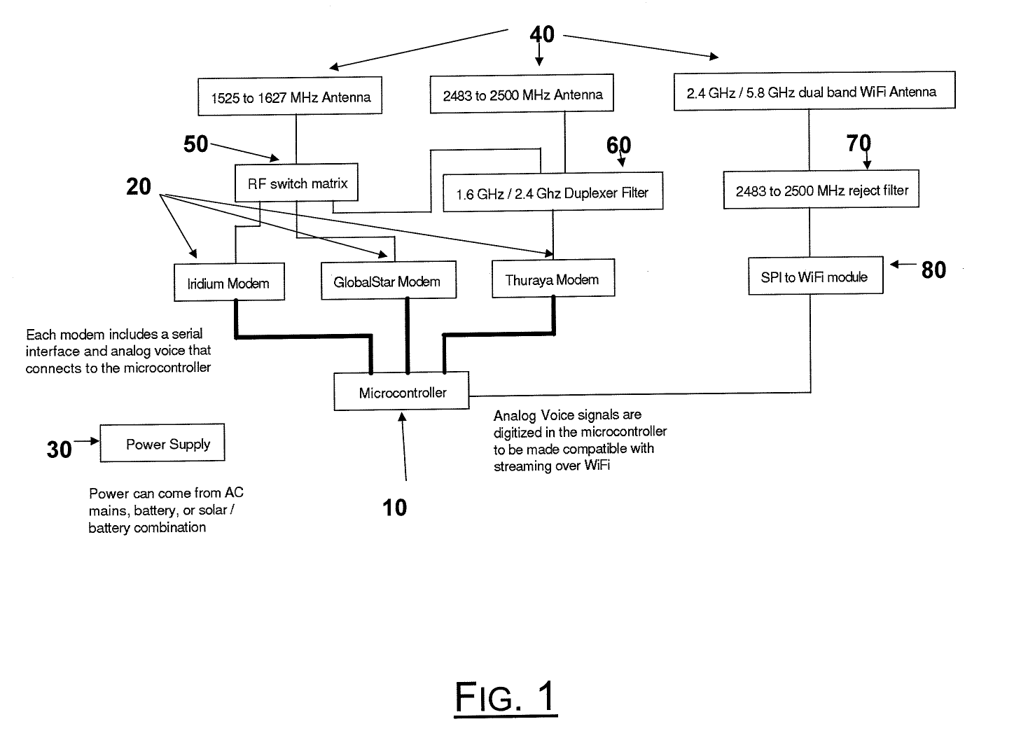

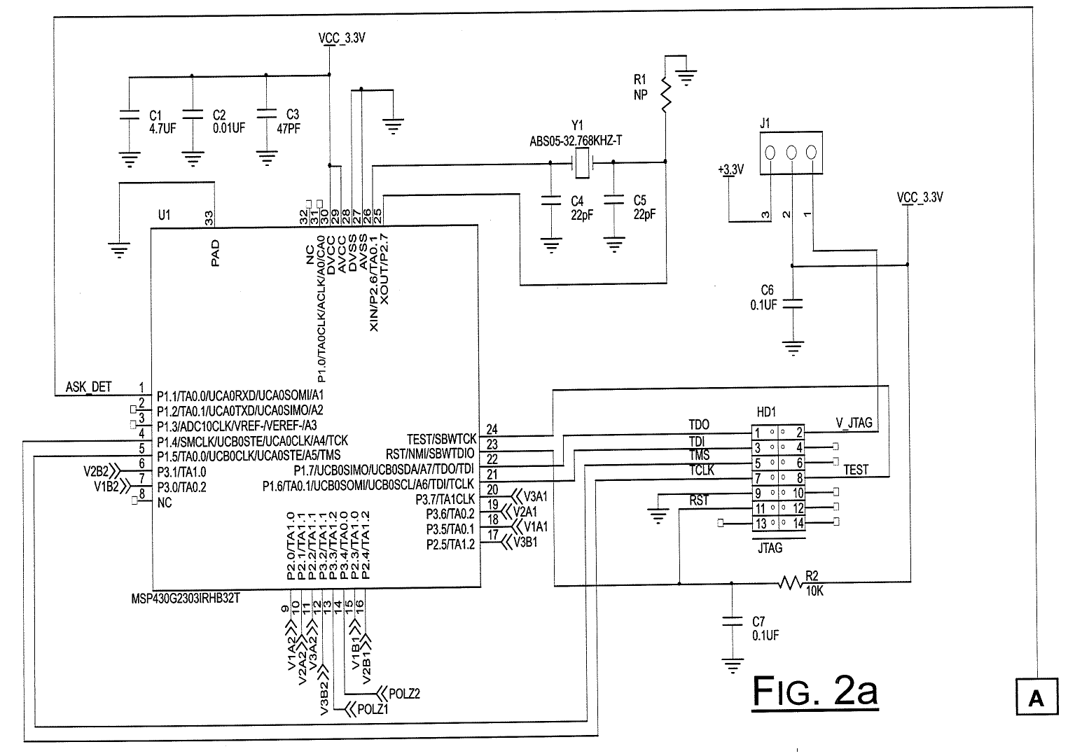

Turning to FIG. 1, which is a block diagram of one particular embodiment of the invention showing its major components. In this embodiment the microcontroller 10 is connected to the satellite modem 20. The microcontroller 10, which can be any commercially available microcontroller with a memory that is capable of receiving machine readable code. The microcontroller 10 provides the brain of the present invention. It runs the algorithm which changes the direction of the antenna beam. It analyzes the beam strength for the best signal. It tracks the beam as it moves. It seeks new signals if a signal is dropped. In some embodiments the microprocessor 10 provides analog to digital and digital to analog conversion of the voice communications. In some embodiment the microprocessor 10 contains information about satellite provider rates and choose which satellite modem 20 to use based on factor such as signal strength and rates per minute.

The satellite modem 20 can be any commercially available modem for satellite communications. Typically, the various satellite communications providers use proprietary modems to access their networks. In these embodiments the satellite modem 20 utilizes the proprietary modems commercially available. In some embodiments a generic modem is used as the satellite modem 20. In some embodiments, only one satellite modem 20 is used. In other embodiments, multiple modems are used.

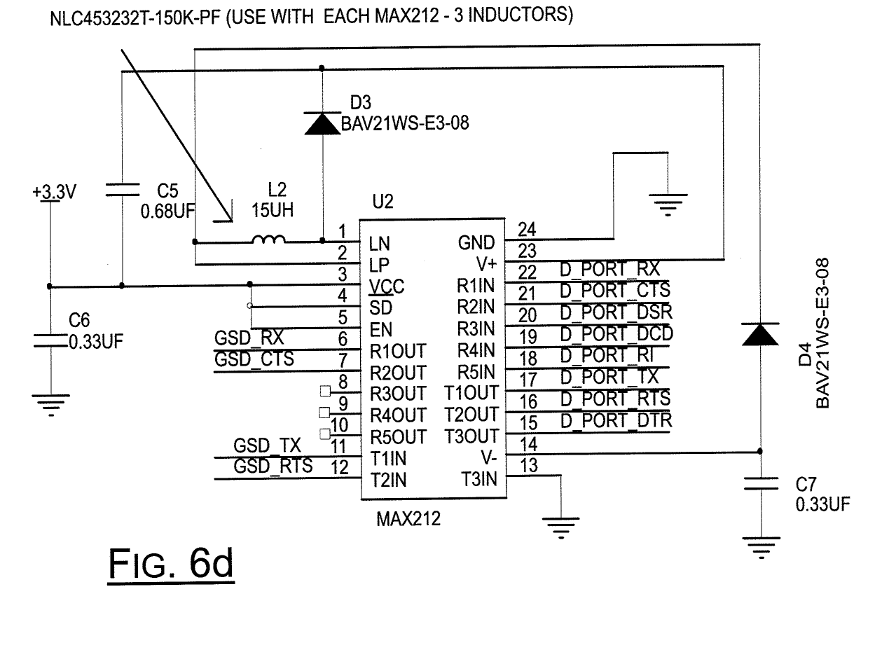

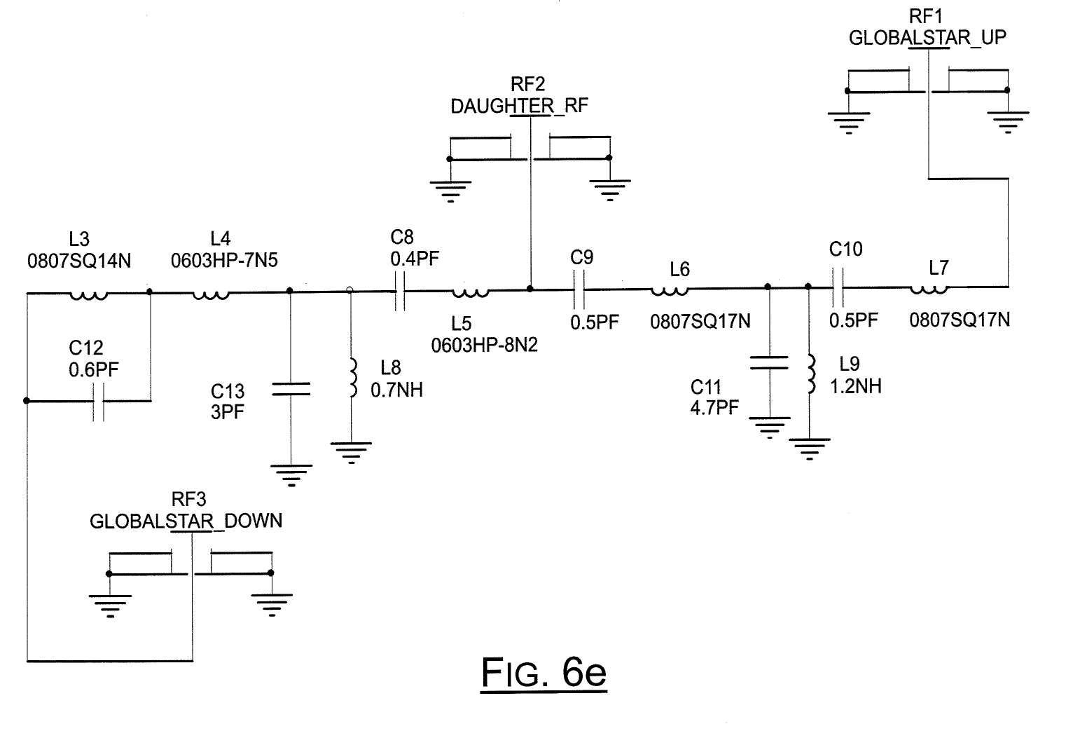

In some embodiments the satellite modem 20 is located on a daughter board (as depicted in FIG. 6). Further such embodiments the daughter board could be a consumer swappable module to the unit. In other embodiments the daughter board is installed by the manufacturer. These embodiments allow customizability to select which particular satellite provider is used by the invention.

In FIG. 1, the satellite modem 20 consists of 3 individual modems: one for each of the major satellite networks, namely Iridium, GlobalStar, and Thuraya. However, as stated, alternate embodiments can use any number of satellite modem 20. The satellite modems 20 are connected to an appropriate antenna 40. In some embodiments, (such as depicted on FIG. 6) the satellite modem 20 is located on a daughter board and the circuit path to the antenna 40 is via standards known in the art. Some satellite networks operate on different radio frequencies, for example in that case of the embodiment in FIG. 1, Iridium and GlobalStar both use frequencies between 1525 to 1627 MHz and thus are connected to an appropriate antenna 40. The dual use of a particular antenna requires the addition of the RF switch matrix 50 which switches the appropriate signal to the appropriate location. In this embodiment, the Thuraya satellite requires a frequency of between 2483 to 2500 MHz and thus is connected to the appropriate antenna 40.

In the embodiment presented in FIG. 1, a 2483 MHz to 2500 MHz reject filter 80 is necessary to allow the microcontroller 10 to send standard WiFi signals as is known in the art, without interfering with the Thuraya satellite signal. The power supply 30 can be any number of power methods including but not limited to AC, battery, solar power or a combination.

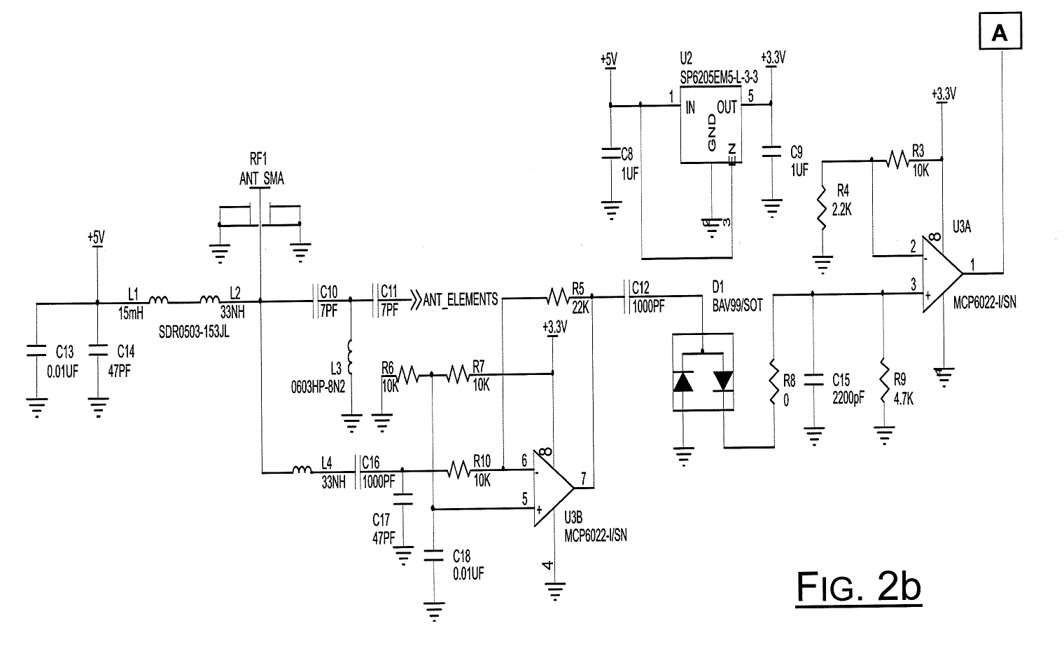

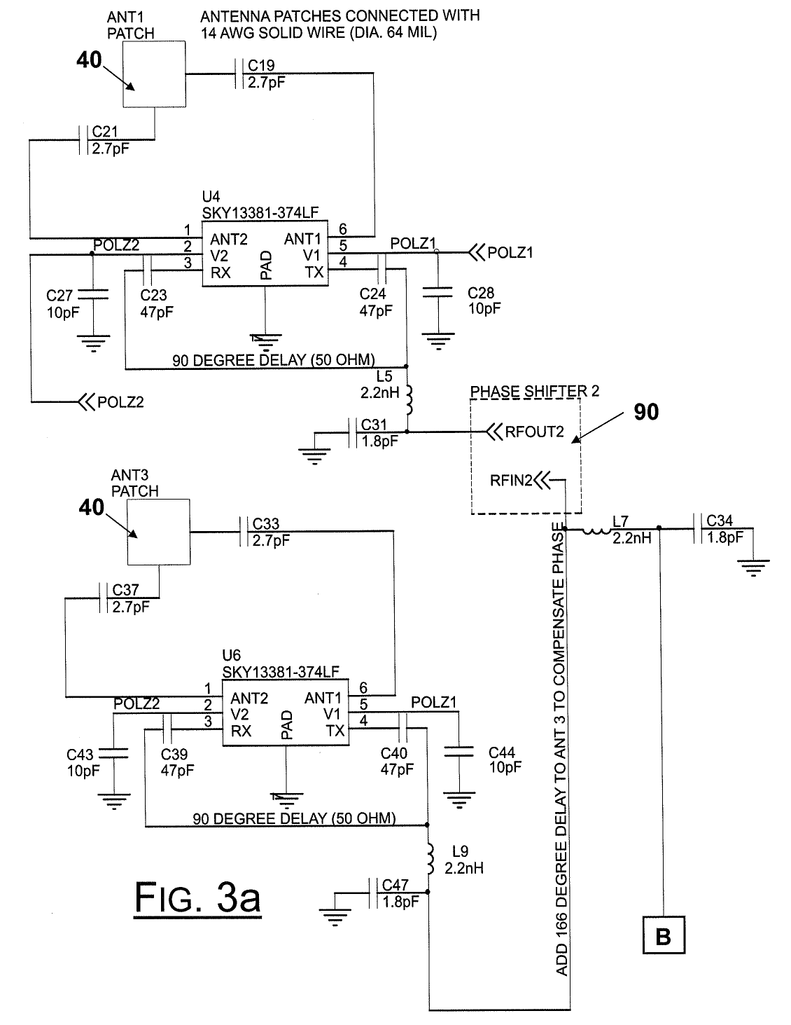

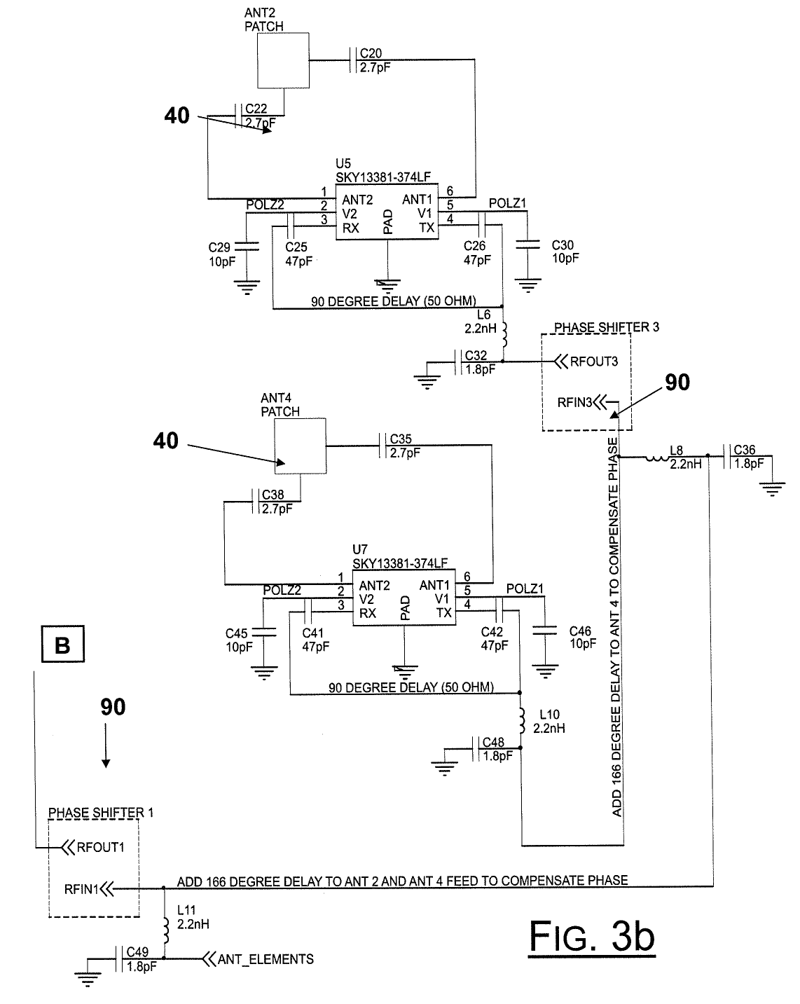

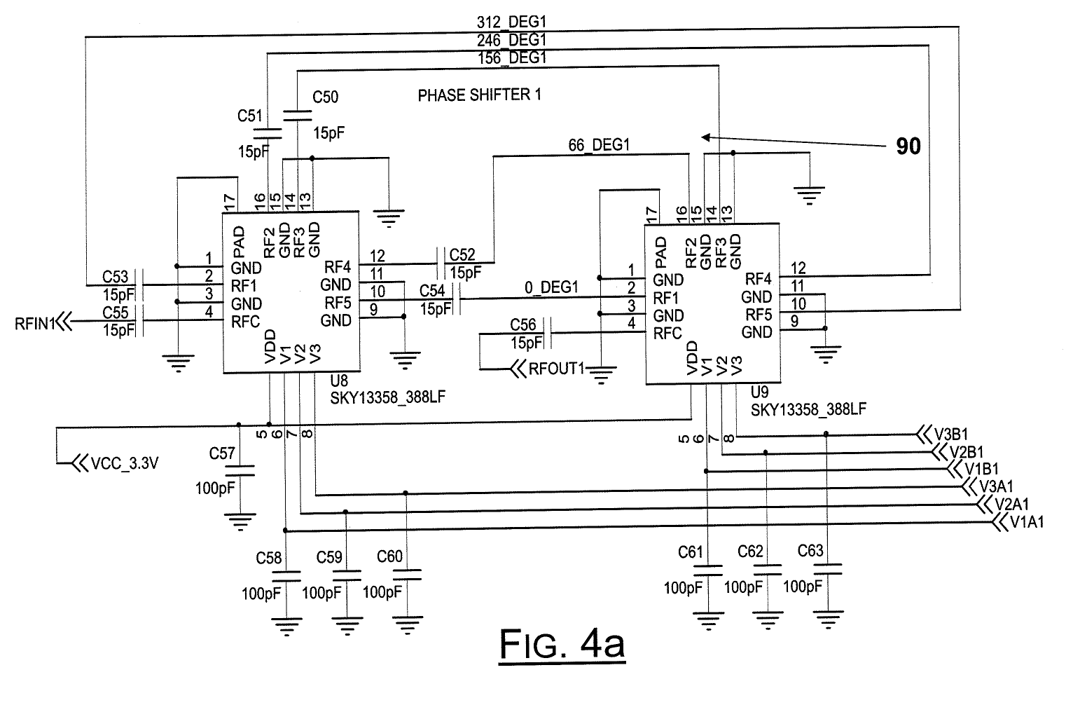

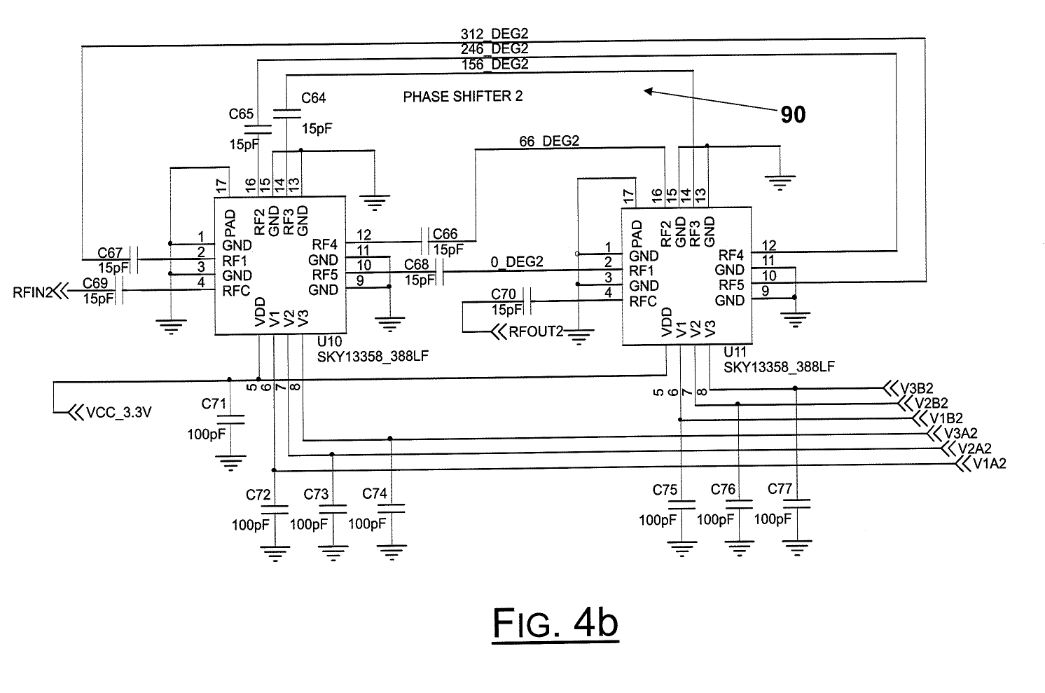

FIGS. 2, 3, 5, 6, and 6 present a circuit diagram of the preferred embodiment of the present invention. The circuit diagram is depicted with elements as is known in the art. FIG. 2 features the circuit diagram of the microcontroller 10. FIG. 3 features the circuit diagram of the antenna patches 40 and phase shifters 90. In the preferred embodiment there are 4 separate antenna patches 40. In alternate embodiments the number of antenna patches 40 may vary based on cost, size limits of the unit, and signal strength considerations. Additionally the number of phase shifters 90 can vary in different embodiments. In the present invention, 3 phase shifters 90 function to direct the antenna beam received from the antenna patches 40.

In the present embodiment the antenna patches 40 are dual band and tuned for both 1.6 GHz and 2.5 GHz. In alternate embodiments, the antenna patches 40 can be optimized for a single frequency ranges or multiple. In some embodiments (as depicted in FIG. 1) the antenna patches 40 could be single use for example, as a WiFi transmitter and receiver or satellite transmitter or receiver. In other embodiments the antenna patches 40 are multi-function for example, using the same set of antenna patches 40 to send and receive both WiFi and satellite signals.

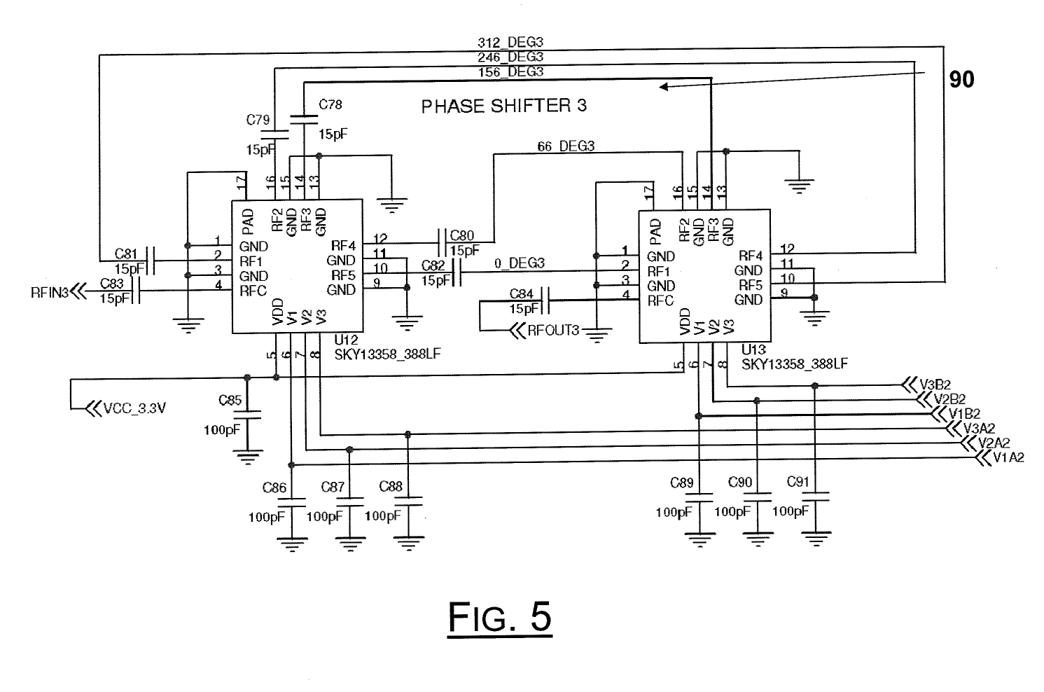

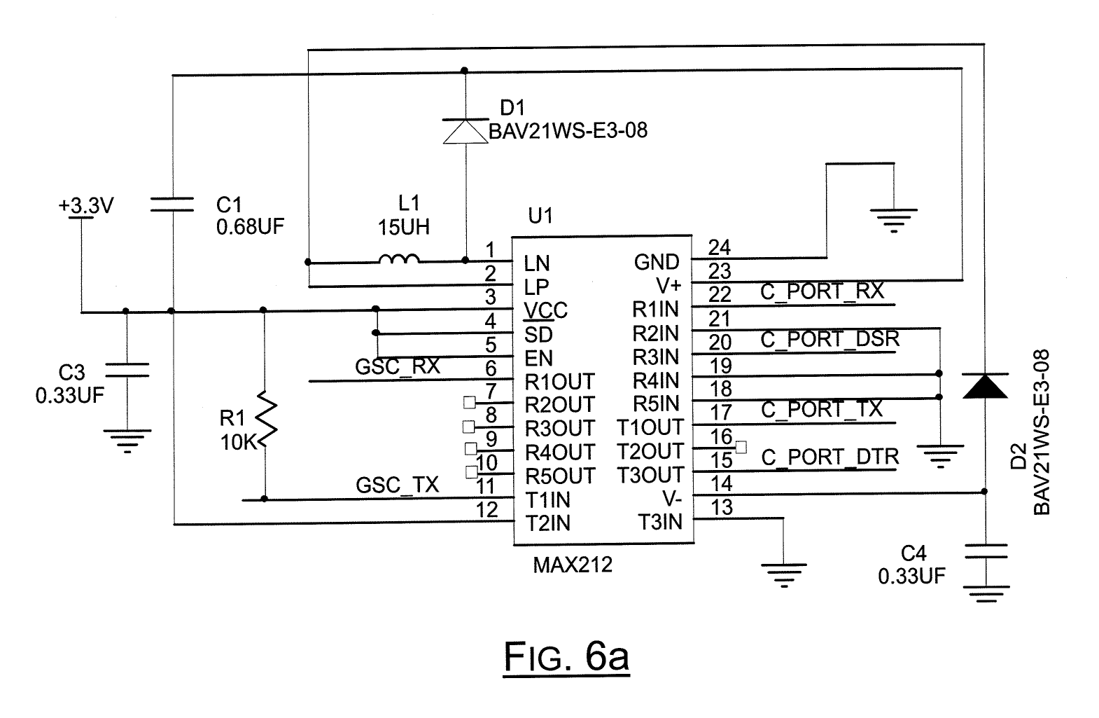

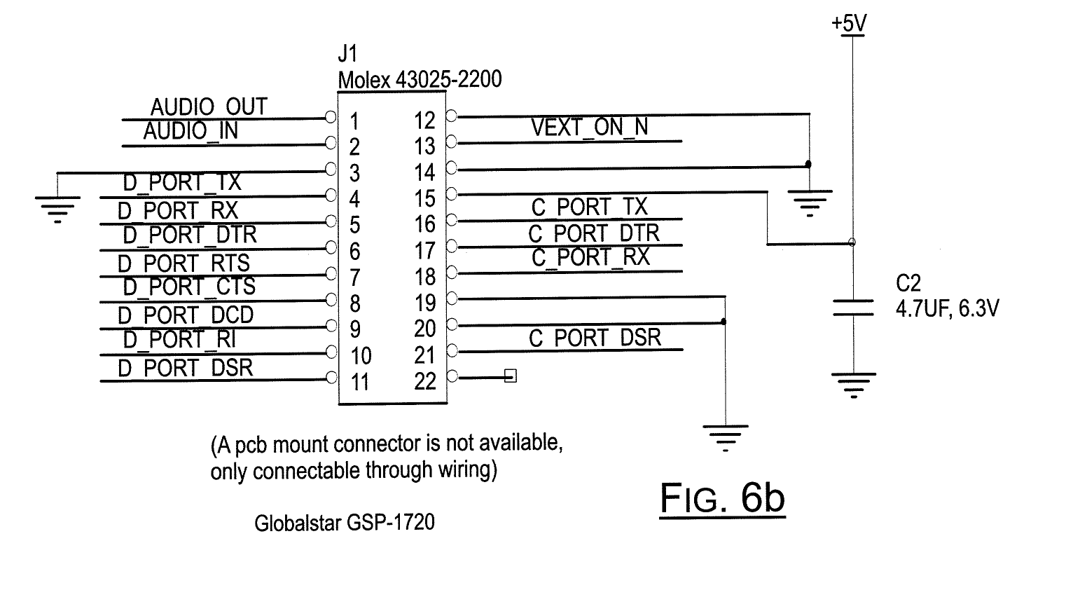

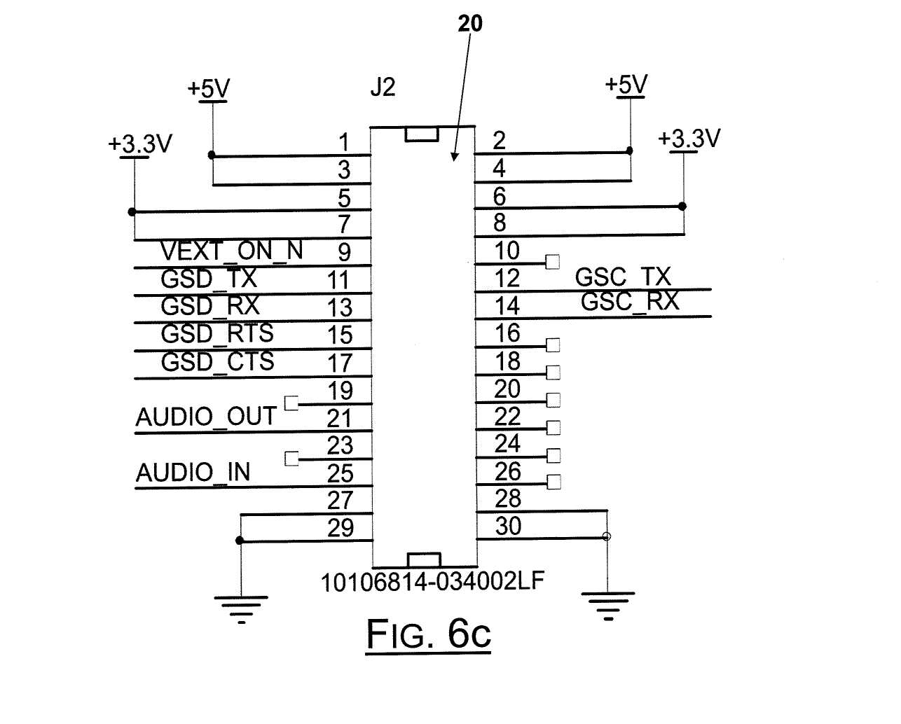

Turning to FIGS. 4 and 5, which are 3 more detailed circuit diagrams of the phase shifters 90 in the preferred embodiment. The phase shifters 90 provide a controllable phase shift to the radio frequency signal received by the antenna patches. The phase shifters 90 in the present invention are configured in length and impedance to optimize the receipt of the desired wavelengths. The following table 1 sets out the optimized information on length and width for the phase shifters depicted in FIGS. 4 and 5 of the preferred embodiment:

TABLE 1
20 mil thick, Er = 3.48

| Degrees | Length (mil) | Width (mil) | Z₀ |
|---|---|---|---|
| 66 | 824 | 40 | 50 |
| 90 | 1124 | 40 | 50 |
| 156 | 1948 | 40 | 50 |
| 166 | 2073 | 40 | 50 |
| 246 | 3072 | 40 | 50 |
| 312 | 3896 | 40 | 50 |
| 90 | 1194 | 6 | 120 |
| 90 | 1093 | 75 | 35 |

The antenna of the present invention could be used in a separate satellite access point, vehicle satellite access devices, mobile satellite phones and other devices. In some embodiments of the present invention, the method and systems described could be provided via computer software. As well, embodiments may come in any known form and may also be implemented by hardware, software, scripting languages, firmware, middleware, microcode, hardware description languages, and/or any combination thereof.

Specific details are given in the above description to provide a thorough understanding of various preferred embodiments. However, it is understood that these and other embodiments may be practiced without these specific details. For example, circuits may be shown in diagrams in order not to obscure the embodiments in unnecessary detail. In other instances, well-known processes, algorithms, structures, and techniques may be shown without unnecessary detail in order to avoid obscuring the embodiments.

Also, it is noted that the embodiments may be described as a process or system which is depicted as a circuit diagram or a block diagram. Although a diagram may describe the operations as a sequential process, many of the operations can be performed in parallel or concurrently. In addition, the order of the operations may be rearranged. A process is terminated when its operations are completed, but could have many additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

While the principles of the disclosure have been described above in connection with specific methods, it is to be clearly understood that this description is made only by way of example and not as limitation on the scope of the disclosure. Whether now known or later discovered, there are countless other alternatives, variations and modifications of the many features of the various described and illustrated embodiments, both in the process and in the system characteristics, that will be evident to those of skill in the art after careful and discerning review of the foregoing descriptions, particularly if they are also able to review all of the various systems and methods that have been tried in the public domain or otherwise described in the prior art. All such alternatives, variations and modifications are contemplated to fall within the scope of the present invention.

Although the present invention has been described in terms of the foregoing preferred and alternative embodiments, these descriptions and embodiments have been provided by way of explanation of examples only, in order to facilitate understanding of the present invention. As such, the descriptions and embodiments are not to be construed as limiting the present invention, the scope of which is limited only by the claims of this and any related patent applications and any amendments thereto.

1. A smart antenna system for transmitting and receiving comprising:
a. a plurality of dual band individual antenna patches tuned for both 1.6 GHz and 2.5 GHz;
b. wherein each of said individual antenna patch is connected to a phase shifter;
c. wherein said phase shifter comprises discrete circuit paths between radio frequency switches;
d. wherein said discrete circuit[s] paths are configured in length to optimize the reception of certain wavelengths from said plurality of individual antenna patches by providing an electrical delay so that desired frequencies are constructively interfered and undesired frequencies are destructively interfered; and
e. a microcontroller configured to select at least one of said discrete circuit paths and to switch between said discrete circuit paths to maximize the reception of the desired frequency.

2. The system as in claim 1 wherein said discrete circuit paths between radio frequency switches include a 66 degree path that is 824 mil in length, a 90 degree path that is 1124 mil in length, a 156 degree path that is 1948 mil in length, a 166 degree path that is 2073 mil in length, a 246 degree path that is 3072 mil in length, a 312 degree path that is 3896 mil in length, a 90 degree path that is 1194 mil in length, and a 90 degree path that is 1093 mil in length.

3. The system as in claim 1 also comprising a satellite modem and radio frequency switch matrix wherein said satellite modem is connected to said microcontroller, said radio frequency switch matrix, and said individual antenna patches also wherein said radio frequency switch matrix is configured to switch the appropriate frequency required by said satellite modem.

4. The system as in claim 3 also comprising a frequency reject filter connected to said microcontroller, said radio frequency switch matrix, and said individual antenna patches wherein said frequency reject filter is configured to broadcast without interfering with reception of signals.

5. The system as in claim 1 also comprising a power supply.

6. The system as in claim 5 wherein said power supply is solar.

7. The system as in claim 5 wherein said power supply is battery.
